(19) United States
(12) Patent Application Publication
(10) Pub. No.: US 2007/0236270 A1
(43) Pub. Date: Oct. 11, 2007

(54) Clock-pulse generator and shift register using the same

(75) Inventors: Chien-Hsueh Chiang, Miao-Li (TW); Sz-Hsiao Chen, Miao-Li (TW); Tsau-Hua Hsieh, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/784,844

(22) Filed: Apr. 9, 2007

(30) Foreign Application Priority Data
Apr. 7, 2006 (TW) 95112473

(51) Int. Cl. G06F 1/04

(52) U.S. Cl. 327/291

(57) ABSTRACT

An exemplary clock-pulse generator (60) includes an input port (63), an output port (64), a logic gate (601) having two inputs (602 and 603) and an output (604), an odd number of inverters (606) connected in series between the input port and one of the inputs of the logic gate, an even number of inverters (607 and 608) connected in series between the input port and the other input of the logic gate, and an inverter (605) connected between the output of the logic gate and the output port. The present invention also provides a shift register (6) using the clock-pulse generator.

### FIELD OF THE INVENTION

This invention relates to clock-pulse generators and shift registers that use a clock-pulse generator, and more particularly to a clock-pulse generator and a shift register typically used in a timing controller of a liquid crystal display device.

### GENERAL BACKGROUND

Shift registers are core circuit units of integrated circuits that are used in thin film transistor liquid crystal displays (TFT-LCDs). A shift register provides sequential pulse signals to scanning lines of a TFT LCD, so as to control on or off states of TFTs connected to the scanning lines.

Referring to FIG. 8, this is a block diagram of a conventional shift register. The shift register 2 includes a pulse generating unit 20, a hybrid latch flip-flop (MHLFF) 25, and a buffer unit 29. The pulse generating unit 20 includes an input 23 and an output 24. The hybrid latch flip-flop 25 includes a pulse signal input 26, a data input 27, and a signal output 28. The output 24 of the pulse generating unit 20 is connected to the pulse signal input 26 of the hybrid latch flip-flop 25, and the signal output 28 of the hybrid latch flip-flop 25 is connected to the buffer unit 29.

The pulse generating unit 20 receives clock signals from the input 23, generates a positive pulse signal according to the clock signals, and then transmits the positive pulse signal to the hybrid latch flip-flop 25 via the pulse signal input 26. The hybrid latch flip-flop 25 generates a plurality of controlling signals according to the positive pulse signal and according to data signals received via the data input 27 and transmits the controlling signals to the buffer unit 29 via the signal output 28. The buffer unit 29 delays and amplifies the controlling signals, and then provides the controlling signals to following circuits.

Referring to FIG. 9, a circuit diagram of the pulse generating unit 20 is shown. The pulse generating unit 20 includes a NAND (Not AND) gate 201, a first inverter 205, a second inverter 206, a third inverter 207, and a fourth inverter 208. A first input 202 of the NAND gate 201 is connected to the input 23, and the second, third and fourth inverters 206, 207 and 208 are connected in series between the input 23 and a second input 203 of the NAND gate 201. The first inverter 205 is connected between an output 204 of the NAND gate 201 and the output 24.

Also referring to FIG. 10, this is a sequence waveform diagram of pulse signals of the pulse generating unit 20 of FIG. 9. Waveform A represents the clock signals inputted at the input 23. Waveform B represents the clock signals of the second input 203, which clock signals are the result of delay and inversion three times by the second, third and fourth inverters 206, 207 and 208. Delaying of the clock signals inputted at the input 23 can be realized by appropriately configuring the ratio of width to length (W/L) of transistors in the inverters 206, 207 and 208. The NAND gate 201 generates a negative pulse signal when the clock signals it receives at the first and second inputs 202 and 203 are both “1”. This negative pulse signal is represented as waveform C. When the negative pulse signal is delayed and inverted by the first inverter 205, the negative pulse signal is converted to a positive pulse signal. The positive pulse signal is transmitted to the hybrid latch flip-flop 25 via the output 24, and is represented as waveform D.

The width of the positive pulse signal is dependent on the clock signals inputted at the first and second inputs 202 and 203 of the NAND gate 201. The clock signals inputted at the second input 203 can be adjusted by configuring the second, third and fourth inverters 206, 207 and 208 appropriately, and/or by configuring one or more additional inverters appropriately. However, the first input 202 is directly connected to the input 23. Therefore delay of the clock signals inputted at the first input 202 cannot be controlled. Thus, the width of pulse signals generated by the NAND 201 cannot necessarily be precisely adjusted. If the width of the pulse signals is too short, the hybrid latch flip-flop 25 is liable to not be triggered when it should be triggered. This means the shift register 2 operates unreliably.

What is needed, therefore, is a clock-pulse generator and a shift register using the clock-pulse generator which can overcome the above-described deficiencies.

### SUMMARY

An exemplary clock-pulse generator includes an input port, an output port, a logic gate having two inputs and an output, an odd number of inverters connected in series between the input port and one of the inputs of the logic gate, an even number of inverters connected in series between the input port and the other input of the logic gate, and an inverter connected between the output of the logic gate and the output port.

An exemplary shift register includes a clock-pulse generator, a hybrid latch flip-flop, and a buffer unit connected in series. The clock-pulse generator includes an input port, an output port, a logic gate comprising two inputs and an output, an odd number of inverters connected in series between the input port and one of the inputs of the logic gate, an even number of inverters connected in series between the input port and the other input of the logic gate, and an inverter connected between the output of the logic gate and the output port.

Other novel features and advantages will become more apparent from the following detailed description when taken in conjunction with the accompanying drawings.

### BRIEF DESCRIPTION OF THE DRAWINGS

FIG. 1 is a circuit diagram of a clock-pulse generator according to a first embodiment of the present invention.

FIG. 2 is a sequence waveform diagram of pulse signals of the clock-pulse generator of FIG. 1.

FIG. 3 is a block diagram of a shift register utilizing the clock-pulse generator of FIG. 1.

FIG. 4 is a circuit diagram of a clock-pulse generator according to a second embodiment of the present invention.

FIG. 5 is a sequence waveform diagram of pulse signals of the clock-pulse generator of FIG. 4.

FIG. 6 is a circuit diagram of a clock-pulse generator according to a third embodiment of the present invention.

FIG. 7 is a sequence waveform diagram of pulse signals of the clock-pulse generator of FIG. 6.

FIG. 8 is a block diagram of a conventional shift register, the shift register including a pulse generating unit.

FIG. 9 is a circuit diagram of the pulse generating unit of FIG. 8.

FIG. 10 is a sequence waveform diagram of pulse signals of the pulse generating unit of FIG. 9.

### DETAILED DESCRIPTION OF PREFERRED EMBODIMENTS

Referring to FIG. 1, a circuit diagram of a clock-pulse generator according to a first embodiment of the present invention is shown. The clock-pulse generator 60 includes an input port 63, an output port 64, a NAND gate 601, a first inverter 605, a second inverter 606, a third inverter 607, and a fourth inverter 608. The second inverter 606 is connected between a first input 602 of the NAND gate 601 and the input port 63. The third and fourth inverters 607 and 608 are connected in series between a second input 603 of the NANAD gate 601 and the input port 63. The first inverter 605 is connected between an output 604 of the NAND gate 601 and the output port 64.

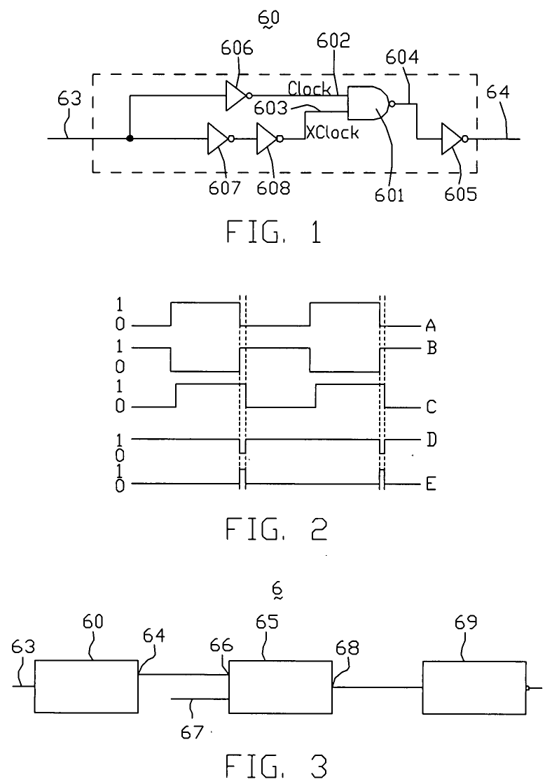

Also referring to FIG. 2, a sequence waveform diagram of pulse signals of the clock-pulse generator 60 of FIG. 1 is shown. Waveform A represents clock signals inputted at the input 63. Waveform B represents the clock signals at the first input 602, which clock signals are the result of delay and inversion by the second inverter 606. Waveform C represents the clock signals at the second input 603, which clock signals are the result of delay and inversion by the third and fourth inverters 607 and 608. Delaying of the clock signals inputted at the first and second inputs 602, 603 can be realized by appropriately configuring the ratio of width to length (W/L) of transistors in the inverters 606, 607 and 608. For example, when the ratio of width to length of the transistor in the second inverter 606 is 10, the waveform of the incoming clock signals will not be delayed. When the ratio of width to length of the transistor in each of the third and fourth inverters 607 and 608 is 0.1, the waveform of the incoming clock signals will be delayed. The NAND gate 601 generates a negative pulse signal when the clock signals it receives at the first and second inputs 602 and 603 are both “1”. This negative pulse signal is represented as waveform D. When the negative pulse signal is delayed and inverted by the first inverter 605, the negative pulse signal is converted to a positive pulse signal. The positive pulse signal is transmitted to following circuits via the output port 64, and is represented as waveform E.

The number of inverters connected between the first and second inputs 602 and 603 of the NAND gate 601 and the input port 63 can be varied. A user can select a suitable number of inverters according to a desired width of the positive pulse signal. Preferably, an odd number of inverters is connected to one of the first and second inputs 602, 603 of the NAND gate 601, and an even number of inverters is connected to the other of the first and second inputs 602, 603 of the NAND gate 601. For example, three inverters are connected between the first input 602 and the input port 63, and four inverters are connected between the second input 603 and the input port 63. That is, the width of the positive pulse signal output from the clock-pulse generator 60 can be controlled according to the delay of the clock signals as inputted at the first and second inputs 602 and 603, which in turn can be controlled by configuring the number of inverters connected to the first and second inputs 602 and 603 accordingly.

Also referring to FIG. 3, a block diagram of a shift register using the clock-pulse generator 60 is shown. The shift register 6 includes the clock-pulse generator 60, a hybrid latch flip-flop (HLFF) 65, and a buffer unit 69. The hybrid latch flip-flop 65 includes a pulse signal input 66, a data input 67, and a signal output 68. The output 64 of the clock-pulse generator 60 is connected to the pulse signal input 66 of the hybrid latch flip-flop 65. The signal output 68 of the hybrid latch flip-flop 65 is connected to the buffer unit 69.

The clock-pulse generator 60 generates a series of positive pulse signals, and provides the positive pulse signals to the hybrid latch flip-flop 65. The hybrid latch flip-flop 65 generates a plurality of controlling signals according to the positive pulse signals and according to data signals received via the data input 67, and transmits the controlling signals to the buffer unit 69 via the signal output 68. The buffer unit 69 delays and amplifies the controlling signals, and provides the controlling signals to following circuits.

The shift register 6 utilizes the clock-pulse generator 60, which generates positive pulse signals that can be accurately controlled. This helps ensure the shift register has high reliability.

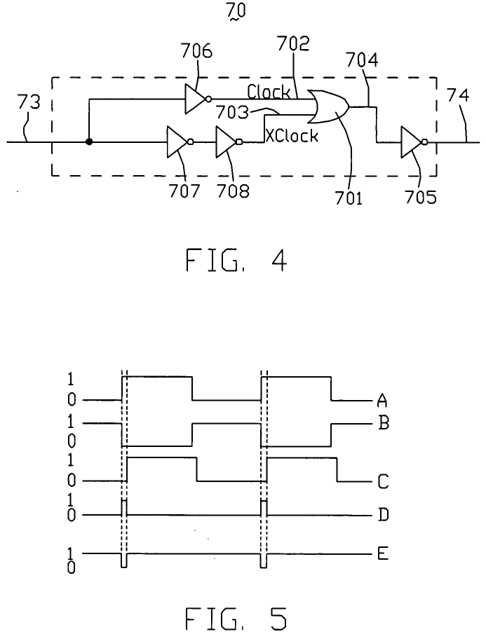

Referring to FIG. 4, a circuit diagram of a clock-pulse generator according to a second embodiment of the present invention is shown. The clock-pulse generator 70 includes an input port 73, an output port 74, a NOR (Not OR) gate 701, a first inverter 705, a second inverter 706, a third inverter 707, and a fourth inverter 708. The second inverter 706 is connected between a first input 702 of the NOR gate 701 and the input port 73. The third and fourth inverters 707 and 708 are connected in series between a second input 703 of the NOR gate 701 and the input port 73. The first inverter 705 is connected between an output 704 of the NOR gate 701 and the output port 74. The difference between the clock-pulse generator 70 and the clock-pulse generator 60 is that the NOR gate 701 generates a positive pulse signal when the clock signals received at the first and second inputs 702 and 703 are both “0”.

Also referring to FIG. 5, a sequence waveform diagram of pulse signals of the clock-pulse generator 70 of FIG. 4 is shown. Waveform A represents clock signals inputted at the input 73. Waveform B represents the clock signals at the first input 702, which clock signals are the result of delay and inversion by the second inverter 706. Waveform C represents the clock signals at the second input 703, which clock signals are the result of delay and inversion by the third and fourth inverters 707 and 708. Waveform D represents a positive pulse signal output at the NOR gate 701. Waveform E represents a negative pulse signal output at the clock-pulse generator 70.

The number of inverters connected between the first and second inputs 702 and 703 of the NOR gate 701 and the input port 73 can be varied. A user can select a suitable number of inverters according to a desired width of the negative pulse signal. Preferably, an odd number of inverters is connected to one of the first and second inputs 702, 703 of the NOR gate 701, and an even number of inverters is connected to the other of the first and second inputs 702, 703 of the NOR gate 701. For example, three inverters are connected between the first input 702 and the input port 73, and four inverters are connected between the second input 703 and the input port 73. That is, the width of the negative pulse signal output from the clock-pulse generator 70 can be controlled according to the delay of the clock signals as inputted format the first and second inputs 702 and 703, which in turn can be controlled by configuring the number of inverters connected to the first and second inputs 702 and 703 accordingly.

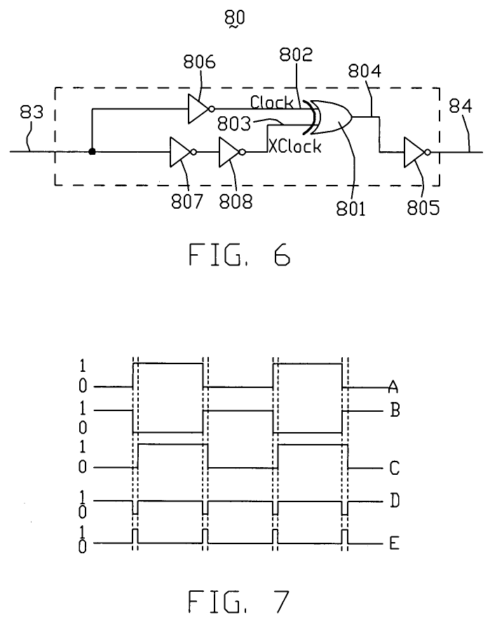

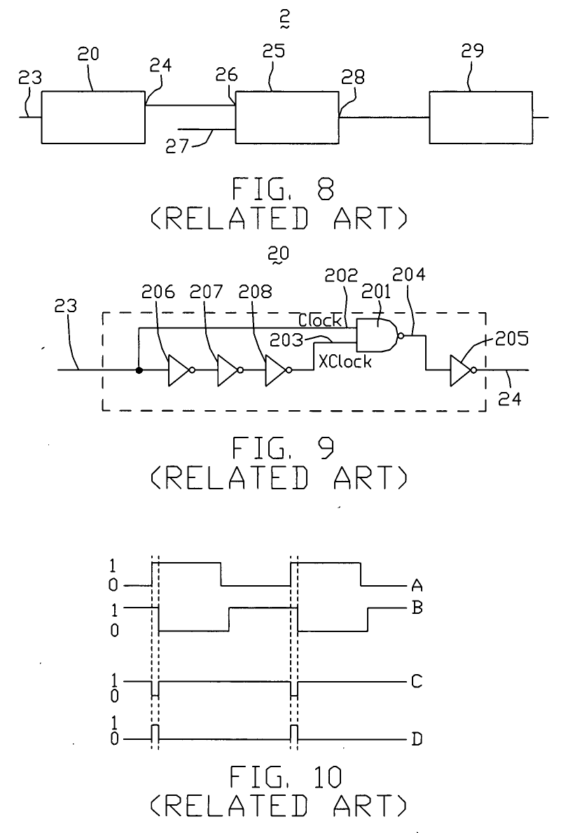

Referring to FIG. 6, a circuit diagram of a clock-pulse generator according to a third embodiment of the present invention is shown. The clock-pulse generator 80 includes an input port 83, an output port 84, an XOR (exclusive OR) gate 801, a first inverter 805, a second inverter 806, a third inverter 807, and a fourth inverter 808. The second inverter 806 is connected between a first input 802 of the XOR gate 801 and the input port 83. The third and fourth inverters 807 and 808 are connected in series between a second input 803 of the XOR gate 801 and the input port 83. The first inverter 805 is connected between an output 804 of the XOR gate 801 and the output port 84. The difference between the clock-pulse generator 80 and the clock-pulse generator 60 is that the XOR gate 801 generates a positive pulse signal when the clock signals received at the first and second inputs 802 and 803 are different; that is, when one of the clock signals is “0”, and the other clock signal is “1”.

Also referring to FIG. 7, a sequence waveform diagram of pulse signals of the clock-pulse generator 80 of FIG. 6 is shown. Waveform A represents clock signals inputted at the input 83. Waveform B represents the clock signals at the first input 802, which clock signals are the result of delay and inversion by the second inverter 806. Waveform C represents the clock signals at the second input 803, which clock signals are the result of delay and inversion by the third and fourth inverters 807 and 808. Waveform D represents a negative pulse signal output at the XOR gate 801. Waveform E represents a positive pulse signal output at the clock-pulse generator 80.

The number of inverters connected between the first and second inputs 802 and 803 of the XOR gate 801 and the input port 83 can be varied. A user can select a suitable number of inverters according to a desired width of the negative pulse signal. Preferably, an odd number of inverters is connected to one of the first and second inputs 802, 803 of the XOR gate 801, and an even number of inverters is connected to the other of the first and second inputs 801, 802 of the XOR gate 801. For example, three inverters are connected between the first input 802 and the input port 83, and four inverters are connected between the second input 803 and the input port 83. That is, the width of the positive pulse signal output from the clock-pulse generator 80 can be controlled according to the delay of the clock signals as inputted at the first and second inputs 802 and 803, which in turn can be controlled by configuring the number of inverters connected to the first and second inputs 802 and 803 accordingly.

In alternative embodiments, the shift register 6 can utilize the clock-pulse generator 70 or the clock-pulse generator 80 to generate pulse signals.

It is to be further understood that even though numerous characteristics and advantages of the present embodiments have been set out in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A clock-pulse generator, comprising:
an input port;
an output port;
a logic gate comprising two inputs and an output;
an odd number of inverters connected in series between the input port and one of the inputs of the logic gate;
an even number of inverters connected in series between the input port and the other input of the logic gate; and
an inverter connected between the output of the logic gate and the output port.

2. The clock-pulse generator as claimed in claim 1, wherein the logic gate is a NAND (Not AND) gate.

3. The clock-pulse generator as claimed in claim 1, wherein the logic gate is a NOR (Not OR) gate.

4. The clock-pulse generator as claimed in claim 1, wherein the logic gate is an XOR (exclusive OR) gate.

5. The clock-pulse generator as claimed in claim 1, wherein the odd number is one.

6. The clock-pulse generator as claimed in claim 5, wherein the even number is two.

7. The clock-pulse generator as claimed in claim 1, wherein the odd number is three.

8. The clock-pulse generator as claimed in claim 7, wherein the even number is four.

9. A shift register, comprising:
a clock-pulse generator, a hybrid latch flip-flop, and a buffer unit connected in series;
wherein the clock-pulse generator comprises:
an input port;
an output port;
a logic gate comprising two inputs and an output;
an odd number of inverters connected in series between the input port and one of the inputs of the logic gate;
an even number of inverters connected in series between the input port and the other input of the logic gate; and
an inverter connected between the output of the logic gate and the output port.

10. The shift register as claimed in claim 9, wherein the logic gate is a NAND (Not AND) gate.

11. The shift register as claimed in claim 9, wherein the logic gate is a NOR (Not OR) gate.

12. The shift register as claimed in claim 9, wherein the logic gate is an XOR (exclusive OR) gate.

13. The shift register as claimed in claim 9, wherein the output port is connected to the hybrid latch flip-flop.
